(19) United States
(12) Patent Application Publication
(10) Pub. No.: US 2013/0257686 A1
(43) Pub. Date: Oct. 3, 2013

(54) DISTRIBUTED VIRTUAL REALITY

(71) Applicants: Elizabeth S. Baron, Saline, MI (US); Daniel H. Orr, Belleville, MI (US); Michael S. Volk, Royal Oak, MI (US)

(72) Inventors: Elizabeth S. Baron, Saline, MI (US); Daniel H. Orr, Belleville, MI (US); Michael S. Volk, Royal Oak, MI (US)

(21) Appl. No.: 13/436,099

(22) Filed: Mar. 30, 2012

(51) Int. Cl. G09G 5/00

(52) U.S. Cl. 345/2.2

(57) ABSTRACT

In a first virtual reality device having a processor and a memory, a virtual reality environment is created. A first stream of tracking data for the virtual reality environment is provided to a first display device that is geographically proximate to the first virtual reality device. The first stream of tracking data for the virtual reality environment is provided to a network for a second virtual reality device. The second virtual reality device is geographically remote from the first virtual reality device. The tracking data includes six degrees of freedom tracking information represented by X,Y,Z Cartesian coordinates, thereby allowing a perspective in the virtual reality environment to be shared between the first virtual reality device and the second virtual reality device.

### BACKGROUND INFORMATION

Virtual environments may be useful for evaluating items such as products under design. In some cases, it may further be useful for users at geographically dispersed locations to simultaneously experience a virtual environment, and participate together in reviewing items, e.g., products, included in the virtual environment. Unfortunately, present mechanisms for sharing virtual environments with remote geographic locations can be cumbersome, difficult to use, and fraught with performance problems. For example, collaboration software may sometimes be used to allow different locations to share a virtual impairment, but such collaboration software is expensive in terms of network and computing resources consumed. Such software, for example, may consume significant amounts of network bandwidth to share audio and video information. Moreover, current mechanisms for sharing virtual environments with remote locations may experience significant latency, and thereby not offer true real-time sharing.

### BRIEF DESCRIPTION OF THE DRAWINGS

FIG. 1a illustrates an exemplary system for sharing an immersive virtual reality environment.

FIG. 1b illustrates an exemplary variation of the system of FIG. 1a for sharing an immersive virtual reality environment.

FIG. 1c illustrates further exemplary variation of the system of FIG. 1a for sharing an immersive virtual reality environment.

FIG. 2 illustrates exemplary details of a virtual reality server.

FIG. 3a illustrates an exemplary process for sharing an immersive virtual reality environment.

FIG. 3b illustrates a further exemplary process for sharing an immersive virtual reality environment.

### DETAILED DESCRIPTION OF PREFERRED EMBODIMENTS

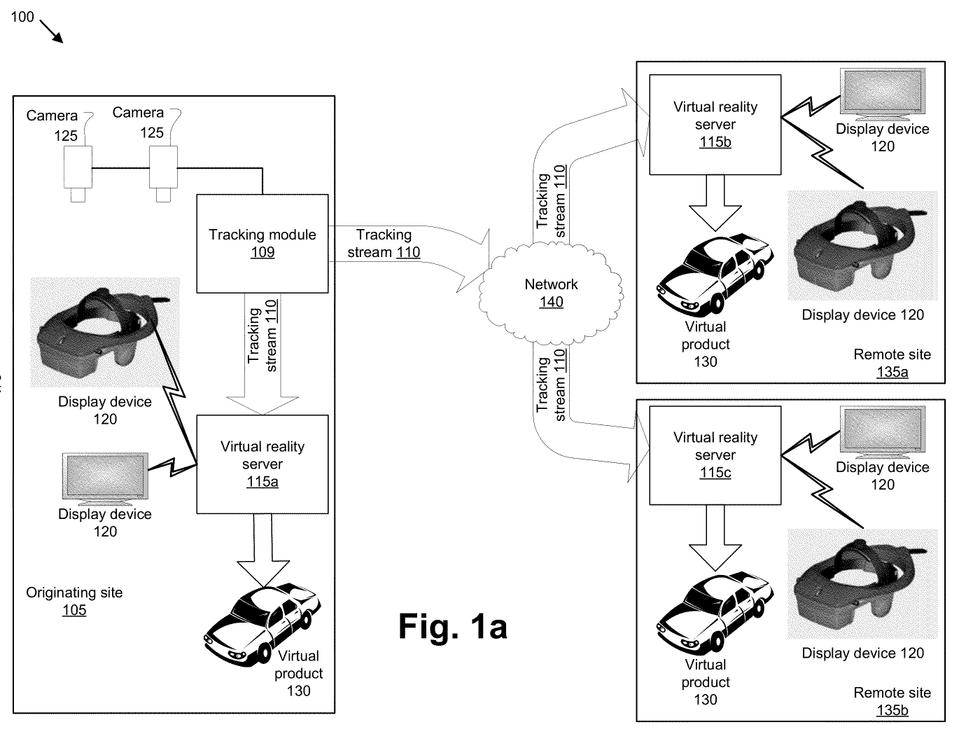

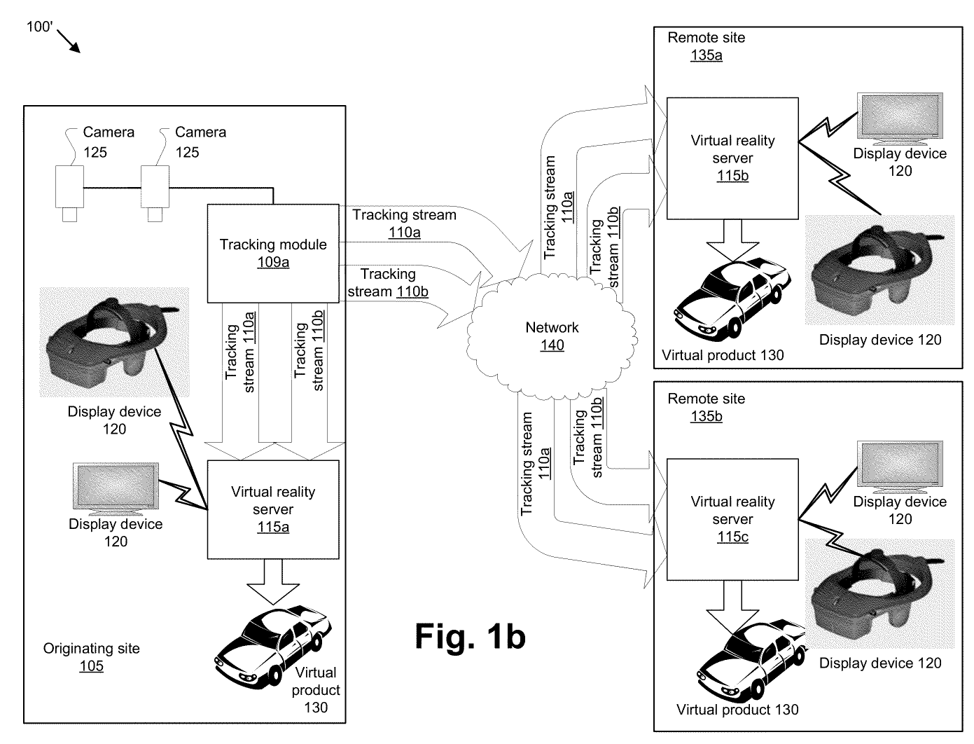

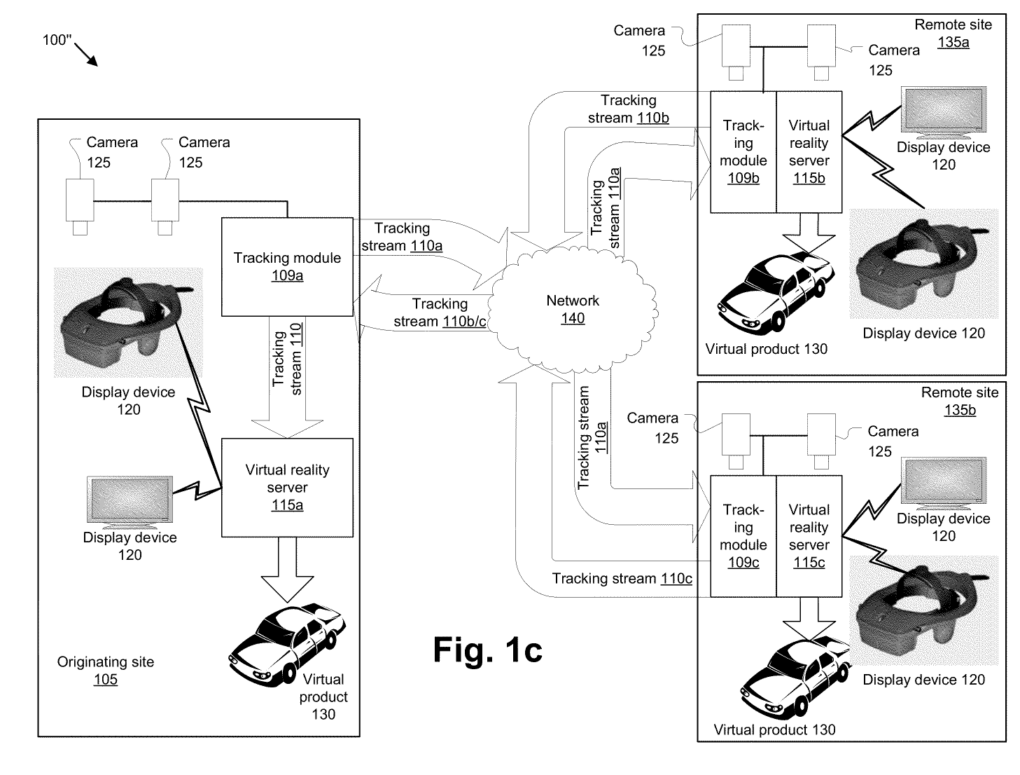

FIG. 1 illustrates an exemplary system 100 for providing an immersive virtual reality environment. The system 100 includes an originating site 105 of a virtual reality environment, as well as one or more remote sites 135 that may receive and use the virtual reality environment, such as remote sites 135a and 135b.

The originating site 105 includes a tracking module 109 that receives raw data from cameras 125, and delivers a tracking stream 110 of virtual-reality data to a virtual reality server 115a. The virtual reality server 115a generates a virtual world, e.g., in monoscopic or, as is usually the case, in stereoscopic format, including a virtual reality environment that in turn may include an item to be evaluated, e.g., a virtual product such as a virtual product 130. As shown in the Figures, product 130 is a virtual vehicle. It is to be understood that the product 130 could be many other kinds of products, and that moreover virtual items other than virtual products could be included and used in the context of the system 100. One or more display devices 120 receive output from the virtual reality server 115 to provide the virtual environment, e.g., such as may include a virtual product 130 or some other item to be viewed and evaluated in the virtual environment.

A user of a display device 120 may interact with the virtual world generated by the virtual reality server 115a, including the virtual product 130. The virtual world may be mapped to a physical environment. The virtual reality server 115a may use the stream 110 of tracking data to provide a perspective of an immersive virtual environment to display devices 120, and may also provide the data in a tracking stream 110 to other virtual-reality servers 115b, 115c, etc., at remote sites 135a, 135b, etc., via a network 140. Thus, one or more users of one or more display devices 120, e.g., a head mounted display, a liquid crystal display screen, etc., may be immersed in the virtual environment generated by the virtual-reality server 115a. Further, the tracking module 109 may provide the tracking stream 110 to remote virtual-reality servers 115b and 115c so that users at the sites 135a, 135b, etc. may likewise be immersed in the same virtual environment according to the tracking stream 110 received by virtual reality servers 115b, 115c, etc.

A tracking stream 110 generally includes, and may be limited to (perhaps also with various metadata), six degree of freedom tracking information represented by X,Y,Z Cartesian coordinates. Further, the tracking stream is generally limited to a such perspective information relating to a virtual environment, and does not more generally include data concerning the virtual environment in which the virtual item is being experienced. That is, each virtual reality server 115 at each site 105, 135 generates a virtual environment, and uses the tracking stream 110 to provide perspective in the virtual environment so that users at remote sites 135 can experience a same perspective as users at the originating site 105.

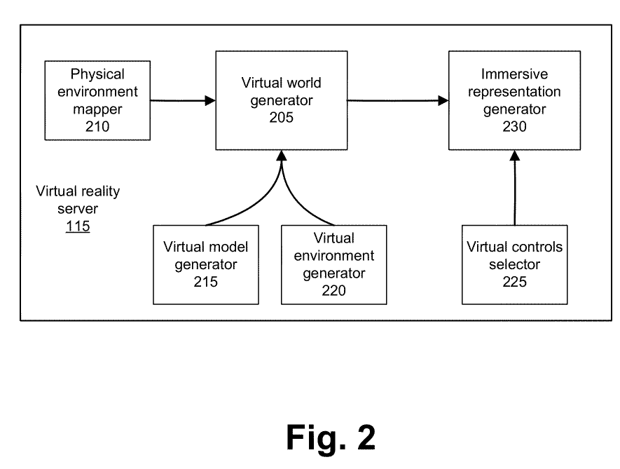

The tracking stream 110 is thus relatively small in size, and consumes relatively little bandwidth, e.g., compared to a stream of video data such as MPEG (Motion Picture Experts Group_data or the like. The tracking stream thus allows real-time immersive collaboration to occur between an originating site 105 and one or more remote sites 135 with minimal network infrastructure. Further, use of a tracking stream 110 avoids the need for heightened security precautions because the data in a tracking stream 110 is generally not classified as sensitive because such data provides only a perspective in the virtual environment for use by an immersive representation generator 230 (discussed below with respect to FIG. 2), and not comprehensive information about the virtual environment or a virtual item such as a virtual product 130, such information generally being pre-installed on the virtual reality servers 115 in the system 100.

Thus, the system 100 is in contrast to traditional approaches to real-time collaboration that require significant investments in network infrastructure to ensure that large amounts of potentially sensitive data, e.g., not merely perspective data included in a tracking stream 110 but an entire view of a virtual item such as a product 130, can be shared to remote sites 135. The distributed virtual reality approach of system 100, in contrast to traditional approaches, advantageously maintains sensitive data within the secured walls of the individual sites 105, 135.

FIG. 1a illustrates a single server 115a and two display devices 120 at the originating site 115a. However, in some implementations, operations attributed herein to server 115a are performed by more than one computer server. Thus, the server 115a illustrated in FIG. 1a may represent a single virtual reality server 115a or may collectively represent virtual-reality servers 115a. Virtual reality servers 115b, 115c, etc. could likewise be one or more actual computer servers in one or more geographic locations. Moreover, the tracking module 109 and the virtual-reality server 115 could be included within a single computing device, or could be included in separate computing devices as is represented in FIG. 1a, e.g., connected via a local area network or the like. Likewise, the originating site 105 may include only one, or more than two, display devices 120, although two display devices 120 are illustrated as included in the originating site 105 in FIG. 1.

Further, turning to FIG. 1b, which illustrates a system 100′ that is an exemplary variation of the system 100 illustrated in FIG. 1a, the server 115a may be configured to present different perspectives, e.g., from different locations, or what are referred to as “optical viewpoints,” of a virtual world via different display devices 120. For example, tracking module 109a could generate a first tracking stream 110a and also a second tracking stream 110b based on inputs received from cameras 125. Virtual reality server 115a in turn could then cause a first display device 120 to present two different views from the two different perspectives, e.g., a view of a front of a vehicle 115a, and a second display device 120 could present a view of a side of a vehicle 115. As further seen in FIG. 1b, two tracking streams 110a and 110b may be provided from the tracking module 109a to the servers 115b and/or 115c at remote sites 135a and/or 135b. Accordingly, users of different devices 120 at a remote site 135 could thereby experience different views of a virtual environment in a product such as virtual product 130, according to respective tracking streams 110a and 110b. Further, although not illustrated in the figures, it should be understood that providing more than two tracking streams 110 is possible in local and/or geographically remote locations.

In addition, turning to Figure lc, which illustrates a system 100″ that is a further exemplary variation of the system 100 illustrated in FIG. 1a, one or more of the remote sites 135 could include cameras 125 and a tracking module 109 for generating a tracking stream 110 that may be provided both to the virtual-reality server 115 at that remote site 135 (although no such tracking stream 110 is shown in FIG. 1c because tracking modules 109b and 109c are shown adjacent to the servers 115b and 115c respectively), as well as to the originating site tracking module 109a, e.g., via the network 140. Thus, in the exemplary implementation shown in FIG. 1c, the site 105 is referred to as “originating” purely as a matter of convention, but in terms of its operations is not necessarily distinguishable from one or more of the remote sites 135. Moreover, although both of the remote sites 135 depicted in FIG. 1c are shown as originating tracking streams 110, implementations are possible in which three or more sites 105, 135 participate in the system 100″, but fewer than the total number of participating sites 105, 135 originate a tracking stream 110.

Various kinds of display devices 120 may be used at any of the sites 105 or 135. For example, a first display device 120 could be a head-mounted display worn by a user and presenting a stereoscopic view of a vehicle, an assembly line, or some other item or environment, and a second display device 120 could be two computer monitors, each presenting one of the two stereoscopic displays provided through the head-mounted display. Display device 120 could also provide audio in addition to visual output. Alternatively or additionally, display device 120 may be a CAVE (CAVE Automated Virtual Environment), a Powerwall (i.e., a large high-resolution display wall used for projecting large computer generated images), a computer monitor such as a high definition television (HDTV), a laptop or tablet computer, etc.

Tracking module 109 may include known software for receiving data from cameras 125 and providing a data stream 110. For example, products such as Vicon Tracker, Vicon Blade, or Vicon Nexus, all from Vicon of Oxford, United Kingdom; the ARTTRACK System from ART of Munich, Germany; the Raptor Real-Time System from Motion Analysis Corporation of Santa, Rosa, Calif.; or the IS-900 inertial/ultrasonic tracking system or the IS-1200 optical/inertial hybrid tracking systems from InterSense in Billerica, Mass., may be used to provide tracking module 109.

Virtual-reality server 115a may include any one of a number of software packages for providing visualization of a virtual environment. Examples of such packages include MotionBuilder® from Autodesk, Inc. of San Rafael, Calif.; the Visual Decision Platform (VDP) from ICIDO of Stuttgart, Germany; Teamcenter from Siemens AG of Munich, Germany; RTT DeltaGen from Realtime Technology AG of Munich, Germany; etc. Using visualization software, the server 115 generates and uses a tracking stream 110 that includes court in data related to the virtual environment, i.e., data in six degrees of freedom, including X, Y, and Z axes, as well as roll, pitch, and yaw data.

FIG. 2 illustrates further exemplary aspects of a virtual reality server 115a, including elements for providing a virtual environment. The system 100 is described in the context of presenting a virtual product 130, but it is to be understood that the systems and methods presently disclosed have application to many different physical items that may be virtually represented, and are not limited to vehicles. As mentioned elsewhere herein, certain elements disclosed in this specification may be implemented according to computer executable instructions stored on a computer readable medium. For example, some or all of the elements described as included in the virtual reality server 115a and/or virtual reality servers 115b and 115c, may be provided according to computer executable instructions stored and executed on virtual reality server 115a.

A virtual world generator 205 generates a virtual model of a product or some other item in a virtual environment, and sometimes mapped to a physical environment. Accordingly, virtual world generator 205 may receive input from a physical environment mapper 210, a virtual model generator 215, and/or a virtual environment generator 220.

An immersive representation generator 230 uses a virtual world generated by virtual world generator 205, along with virtual controls provided by a virtual controls selector 225, e.g., according to program instructions included in the immersive representation generator 230 to provide positioning and orientation in the virtual world, to provide a user with an immersive virtual representation of a vehicle from the user's perspective.

Further, immersive representation generator 230 may provide different user perspectives a virtual world according to a user selection, e.g., via a virtual controls selector 225. For example, a user may be provided different perspectives of a virtual world according to different virtual heights of the user. That is, a user could be given a perspective of a virtual world that a 6′1″ tall person would have, and then, according to a selection of a virtual controls selector 225, begin in a perspective of a virtual world that a 5′4″ person would have. The ability to provide different user perspectives advantageously allows a user to experience a virtual world, and a vehicle in the virtual world, from the perspective of people with differing virtual attributes. In addition, the immersive representation generator 230 may provide different perspectives to different users of the virtual world, e.g., a first user may have a perspective of standing near the hood of a virtual product 130, while a second user may have a perspective of standing near the trunk of the virtual product 130.

Physical environment mapper 210 is an optional component that is used to register a virtual reality coordinate system to real world, i.e., physical, objects. For example, a vehicle mockup may be provided with various points such as seats, a dashboard, steering wheel, instrument panel, etc. Accordingly, to allow a user of display device 120 to interact with the virtual world provided by virtual world generator 205 and immersive representation generator 230, physical environment mapper 210 may be used to map points in a physical framework, e.g., a mockup of a vehicle, to a coordinate system used by the virtual world generator 205. For example, points may be oriented with respect to the ground, and may include vehicle points based on vehicle dimensions such as height of the vehicle from the ground, height of doors, interior width at various points, etc. Further, coordinate system used by physical environment mapper 210 may include a mechanism for scaling a virtual world to properly mapped to the coordinate system for the physical world.

Virtual model generator 215 provides a virtual model of a product such as a vehicle so that a complete product model may be provided in the virtual world generated by virtual world generator 205. Virtual model generator 215 makes use of what is sometimes referred to as a nominal geometry, i.e., a geometry that provides all of the basic elements of a product such as a vehicle. Further, virtual model generator 215 may use what is sometimes referred to as an appearance database, i.e., a data store of various textures, shaders, etc., that may be applied to a product such as a vehicle. For example, a vehicle may be modeled with leather seats and a tan interior, cloth seats and a black interior, etc. Numerous different components of a vehicle may have different textures, colors, etc. In addition, the nominal geometry includes coordinate information for various product components.

Virtual environment generator 220 is used to generate aspects of a virtual world other than a product, e.g., a vehicle, representation. For example, virtual environment generator 220 receives input with respect to lighting in a virtual world, illustrates shadows and reflections, and provides perspective and provides background geometry to complete the user's virtual world, e.g., to determine a setting in which a virtual product 103 is experienced, e.g., a cityscape, a rural setting, etc. With respect to lighting, ray tracing, which calculates how light bounces from one surface to another, may be important, and may enhance a virtual representation. With respect to perspective, virtual environment generator 220 may provide a perspective for a person of a certain height. As mentioned above, immersive representation generator 230 may make available different perspectives in a virtual environment.

In addition, virtual environment generator 220 may control what is sometimes referred to as a variation mapping. That is, different virtual models, e.g., according to different nominal geometries, may be provided by virtual model generator 215 and mapped to different varied geometries 240.

Virtual controls selector 225 provides a mechanism for selecting controls of an input device, e.g., keyboard, mouse, pointing device, etc., that can be used to select various events in the virtual world provided by virtual world generator 205. For example, various aspects of a virtual model could be subject to change according to user input, e.g., a type or location of a gear shift lever, dashboard controls, various styling choices, etc.

Immersive representation generator 230 combines the virtual world provided by virtual world generator 205 with virtual controls provided by virtual controls selector 225, taking into account the location of the user within the virtual world, and the continuously updated position and orientation of the view of the user in the physical world, to provide an immersive representation of a product such as a vehicle. Accordingly, a user, e.g., using display 115, can experience the generated virtual world, and can control aspects of the virtual world using provided virtual controls. The representation is described as immersive because the user generally has no other visual experience other than a view of the virtual world provided by the system 100. Output of immersive representation generator may include a tracking stream 110 that may be used not only to provide a virtual experience for users of devices 120 in the originating site 105, but also for users of devices 120 at remote sites 135.

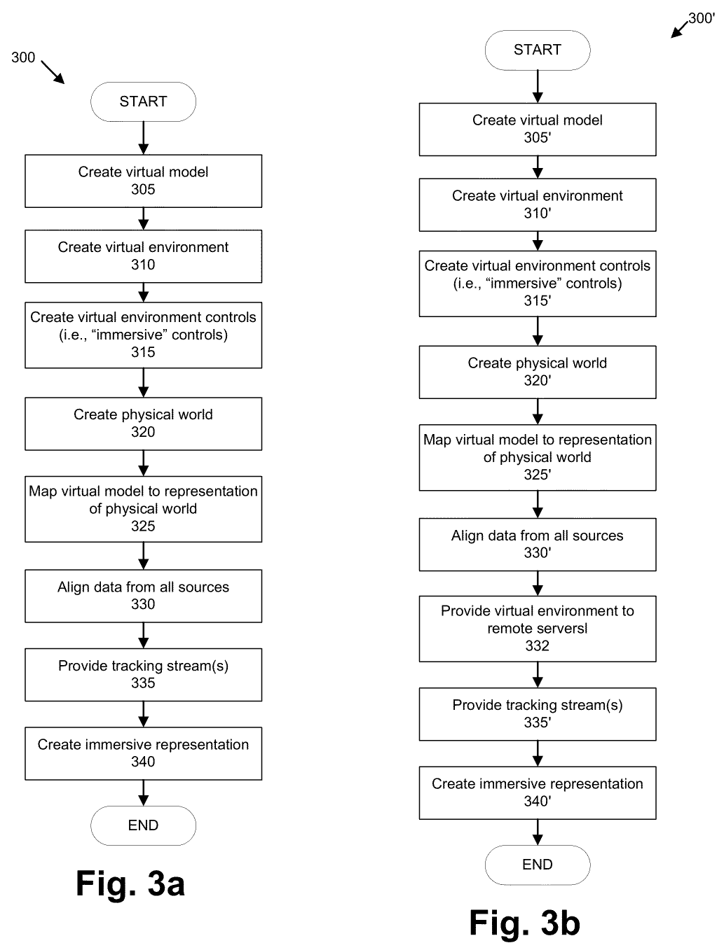

FIG. 3a illustrates an exemplary process 300 for providing a tracking stream 110 from an originating site 105 to a remote site 135.

The process 300 begins in a step 305, in which virtual model generator 215, included in a virtual reality server 115 at an originating site 105, is used to create a virtual model of a product, e.g., a vehicle, for use in a virtual world.

Next, in step 310, virtual environment generator 220 is used to create a virtual environment in which the model created in step 305 may be included.

Next, in step 315, virtual controls selector 225 is used to create virtual environment controls, sometimes referred to as immersive controls, for use when viewing a virtual model of a vehicle.

Next, in step 320, physical environment mapper 210 is used to match a physical world associated with the virtual environment created in step 310. That is, a coordinate system is imposed on a physical environment with points that may be mapped to the virtual environment.

Next, in step 325, physical environment mapper 210 maps the physical world to the virtual environment. Note that, as mentioned above, mapping the virtual environment to a physical environment is optional, and may be omitted in some implementations.

Next, in step 330, virtual world generator 205 aligns all data to be included in the virtual world. For example, after the physical world is mapped to the virtual environment, the virtual model generated as discussed with respect to step 305 must be placed in the virtual environment.

Next, in step 335, virtual reality server 115 receives a data stream 110, e.g., from tracking module 109. Further, more than one virtual reality server 115 may receive the data stream 110, e.g., virtual reality servers at different sites 105 and 135.

Next, in step 340, immersive representation generator 230, using the data stream 110 received in step 335, along with the virtual environment and virtual model discussed above with respect to steps 305-330, generates an immersive representation that may be experienced by a user of display 120 and/or virtual reality server 115a, server 115a including instructions for tracking position and/or orientation.

Step 340 may be continued as long as a data stream 110 is being provided, and the virtual environment in virtual model are maintained. Once step 340 terminates, the process 300 ends.

Process 300 is described above with respect to the exemplary implementation of the system 100 shown in Figure la. However, the process 300 need to be varied only slightly for the exemplary implementation of the system 100′ shown in FIG. 2b. With respect to the system 100′, in step 335, the virtual reality servers 115 at the sites 105 and 135 would receive not just one, but multiple, data streams 110.

Further, with respect to the exemplary system 100″ shown in Figure lc, a process 300′ may be conducted, as illustrated in FIG. 3b.

The process 300′ begins in a step 305′, in which virtual model generator 215, included in a virtual reality server 115 at an originating site 105, is used to create a virtual model of a product, e.g., a vehicle, for use in a virtual world.

Next, in step 310′, virtual environment generator 220 is used to create a virtual environment in which the model created in step 305′ may be included.

Next, in step 315′, virtual controls selector 225 is used to create virtual environment controls, sometimes referred to as immersive controls, for use when viewing a virtual model of a vehicle.

Next, in step 320′, physical environment mapper 210 is used to match a physical world associated with the virtual environment created in step 310. That is, a coordinate system is imposed on a physical environment with points that may be mapped to the virtual environment.

Next, in step 325′, physical environment mapper 210 maps the physical world to the virtual environment. Note that, as mentioned above, mapping the virtual environment to a physical environment is optional, and may be omitted in some implementations.

Next, in step 330′, virtual world generator 205 aligns all data to be included in the virtual world. For example, after the physical world is mapped to the virtual environment, the virtual model generated as discussed with respect to step 305′ must be placed in the virtual environment.

Next, in step 332, virtual server 115a at the originating site 105 provides the virtual environment, including, e.g., the virtual product 130, to remote virtual servers 115b, 115c, etc.

Next, in step 335′, each virtual reality server 115 receives each of a plurality of data streams 110, e.g., from tracking module 109, wherein each of the data streams 110 is generated by a tracking module 109 at one of the sites 105, 135. Thus, any given virtual reality server 115 in the system 100″ may receive multiple data streams 110 from multiple sites 105, 135. Further, more than one virtual reality server 115 may receive any given data stream 110, e.g., virtual reality servers at different sites 105 and 135.

Next, in step 340′, immersive representation generator 230, using the data streams 110 received in step 335′, along with the virtual environment and virtual model discussed above with respect to steps 305′-332, generates an immersive representation that may be experienced by a user of display 120 and/or virtual reality server 115a, server 115a including instructions for tracking position and/or orientation.

Step 340′ may be continued as long as a data stream 110 is being provided, and the virtual environment in virtual model are maintained. Once step 340 terminates, the process 300 ends.

Computing devices such as virtual reality server 115a, etc. may employ any of a number of computer operating systems known to those skilled in the art, including, but by no means limited to, known versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, Apple OS-X Operating Systems, and/or Mobile and Tablet Operating Systems such as Android, from the Open Handset Alliance consortium (including Google), and Apple's iOS for iPad, iPhone and iPod Touch,. Computing devices may include any one of a number of computing devices known to those skilled in the art, including, without limitation, a computer workstation, a desktop, notebook, laptop, tablet computer, smartphone, or handheld computer, or some other computing device known to those skilled in the art.

Computing devices such as the foregoing generally each include instructions executable by one or more computing devices such as those listed above. Computer-executable instructions may be compiled or interpreted from computer programs created using a variety of programming languages and/or technologies known to those skilled in the art, including, without limitation, and either alone or in combination, Java™, C, C++, Visual Basic, Java Script, Python, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium includes any medium that participates in providing data (e.g., instructions), which may be read by a computer. Such a medium may take many forms, including, but not limited to, non-volatile media, volatile media, and transmission media. Non-volatile media include, for example, optical or magnetic disks and other persistent memory. Volatile media include dynamic random access memory (DRAM), which typically constitutes a main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, Blu-Ray, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system, comprising:
a first virtual reality device that includes a processor and a memory, the memory storing a first set of instructions executable by the processor for:
generating a virtual reality environment;
providing a first stream of tracking data for the virtual reality environment to a first display device that is geographically proximate to the first virtual reality device; and
providing the first stream of tracking data for the virtual reality environment to a network for a second virtual reality device, wherein the second virtual reality device is geographically remote from the first virtual reality device; and
further wherein the tracking data includes six degrees of freedom tracking information represented by X,Y,Z Cartesian coordinates, thereby allowing a perspective in the virtual reality environment to be shared between the first virtual reality device and the second virtual reality device.

2. The system of claim 1, further comprising the second virtual reality device, the second virtual reality device including a processor and a memory, the memory of the second virtual reality device storing a second set of instructions executable by the processor for generating the virtual reality environment.

3. The system of claim 2, the second set of instructions further including instructions for providing a second tracking stream to the first virtual reality device.

4. The system of claim 3, wherein the first tracking stream is based on a first optical viewpoint in the virtual reality environment and the second tracking stream is based on a second optical viewpoint in the virtual reality environment.

5. The system of claim 3, the second set of instructions further including instructions for providing the first tracking stream to a display device that is geographically proximate to the second virtual reality device.

6. The system of claim 1, wherein the virtual reality environment includes a virtual product.

7. The system of claim 1, wherein a second display device is geographically proximate to the a first display device.

8. A method, comprising:
creating, in a first virtual reality device having a processor and a memory, a virtual reality environment;
providing a first stream of tracking data for the virtual reality environment to a first display device that is geographically proximate to the first virtual reality device; and
providing the first stream of tracking data for the virtual reality environment to a network for a second virtual reality device, wherein the second virtual reality device is geographically remote from the first virtual reality device; and
further wherein the tracking data includes six degrees of freedom tracking information represented by X,Y,Z Cartesian coordinates, thereby allowing a perspective in the virtual reality environment to be shared between the first virtual reality device and the second virtual reality device.

9. The method of claim 8, further comprising providing a second tracking stream to the first virtual reality device.

10. The method of claim 9, wherein the first tracking stream is based on a first optical viewpoint in the virtual reality environment and the second tracking stream is based on a second optical viewpoint in the virtual reality environment.

11. The method of claim 9, further comprising providing the first tracking stream to a display device that is geographically proximate to the second virtual reality device.

12. The method of claim 8, wherein the virtual reality environment includes a virtual product.

13. The method of claim 8, wherein a second display device is geographically proximate to the a first display device.

14. A non-transitory computer-readable medium tangibly embodying computer executable instructions, the instructions including instructions for:
creating, in a first virtual reality device having a processor and a memory, a virtual reality environment;
providing a first stream of tracking data for the virtual reality environment to a first display device that is geographically proximate to the first virtual reality device; and
providing the first stream of tracking data for the virtual reality environment to a network for a second virtual reality device, wherein the second virtual reality device is geographically remote from the first virtual reality device; and
further wherein the tracking data includes six degrees of freedom tracking information represented by X,Y,Z Cartesian coordinates, thereby allowing a perspective in the virtual reality environment to be shared between the first virtual reality device and the second virtual reality device.

15. The method of claim 8, further comprising providing a second tracking stream to the first virtual reality device.

16. The method of claim 9, wherein the first tracking stream is based on a first optical viewpoint in the virtual reality environment and the second tracking stream is based on a second optical viewpoint in the virtual reality environment.

17. The method of claim 9, further comprising providing the first tracking stream to a display device that is geographically proximate to the second virtual reality device.

18. The method of claim 8, wherein the virtual reality environment includes a virtual product.

19. The method of claim 8, wherein a second display device is geographically proximate to the a first display device.
